(19) United States
(12) Patent Application Publication
(10) Pub. No.: US 2007/0298964 A1
(43) Pub. Date: Dec. 27, 2007

(54) Preparation Method Of Solid Titanium Catalyst For Olefin Polymerization

(75) Inventors: Chun-Byung Yang, Daejeon (KR); Ho-Sik Chang, Daejeon (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS CO., LTD., (KR)

(21) Appl. No.: 10/598,170

(22) PCT Filed: Oct. 15, 2004
(86) PCT No.: PCT/KR04/02640

§ 371 Date: Apr. 23, 2007

(30) Foreign Application Priority Data
Feb. 27, 2004 (KR) 10-2004-0013469

(51) Int. Cl. C08F 4/64; B01J 31/00; C08F 10/00; C08F 4/654; C08F 4/10

(52) U.S. Cl. 502/350

(57) ABSTRACT

The present invention relates to a preparation method of solid titanium catalyst for olefin polymerization comprising the steps of: 1) preparing a magnesium compound solution by dissolving a magnesium halide compound into a mixed solvent of a cyclic ether and one or more of alcohol; (2) preparing a carrier by, adding a mixture of titanium compound and halogenated hydrocarbon to the magnesium compound solution at low temperature and then elevating the temperature of the resulted solution for reaction; and (3) preparing a solid titanium catalyst by reacting the carrier with a titanium compound and an electron donor.

### TECHNICAL FIELD

The present invention relates to a preparation method of a solid titanium catalyst for olefin polymerization. Particularly, the present invention relates to a preparation method of a solid titanium catalyst for olefin polymerization, which comprises the steps of: (1) preparing a magnesium compound solution by dissolving a magnesium halide compound into a mixed solvent of a cyclic ether and one or more of alcohol; (2) preparing a carrier by, adding a mixture of titanium compound and halogenated hydrocarbon to the magnesium compound solution at low temperature and then elevating the temperature of the resulted solution for reaction; and (3) preparing a solid titanium catalyst by reacting the carrier with a titanium compound and an electron donor.

### BACKGROUND ART

A number of catalysts for olefin polymerization and polymerization processes have been developed so far. However, in order to obtain more sufficient commercial benefits out of such developed catalysts, there have been still great demands for further development on the activity and production yield of a catalyst itself to raise the whole productivity, or on properties of a polymer produced by those developed catalysts to improve the product quality.

There have been reported so far many titanium-based catalysts for olefin polymerization containing magnesium and preparation processes thereof, and also a number of catalyst preparation methods are known in this art, wherein a magnesium compound solution is used in order to control the shape or size, etc. of a catalyst. Methods for obtaining a magnesium compound solution by reacting a magnesium compound with an electron donor such as alcohol, amine, ether, ester, carboxylic acid and the like, in the presence of a hydrocarbon solvent, are commonly known. Among those methods, methods using alcohol are disclosed in U.S. Pat. Nos. 4,330,649 and 5,106,807, and Japanese Patent Laid-Open Sho-58-83006. Further, various methods for preparing a magnesium solution are found in U.S. Pat. Nos. 4,315,874, 4,399,054 and 4,071,674. Particularly, tetrahydrofuran, which is a cyclic ether, has been variously used, for example, to a magnesium chloride compound in U.S. Pat. No. 4,482,687, as an additive for a cocatalyst in U.S. Pat. No. 4,158,642, as a solvent in U.S. Pat. No. 4,477,639 and the like.

Further, U.S. Pat. Nos. 4,347,158, 4,422,957, 4,425,257, 4,618,661 and 4,680,381 disclose a method for preparing a catalyst by adding a Lewis acid compound such as aluminum chloride to a magnesium chloride support and then grinding the mixture.

However, according to those foregoing conventional arts, catalyst production yield is low and catalyst properties are not satisfying enough, regarding its morphological properties such as catalyst shape, size and size distribution, and further complement or improvement in stereoregularity of the obtained polymers is also required.

Therefore, to improve the commercial value of such catalyst for olefin polymerization, still required is a preparation method for a catalyst, with high catalyst production yield, having high polymerization activity and controlled shape and size and being capable of providing a polymer with high stereoregularity so as to improve both productivity and product quality.

### DISCLOSURE

As a result of repeated researches for solving above-mentioned problems of the conventional arts, the inventors found that a catalyst with controlled shape and size can be obtained at high yield: by dissolving a magnesium halide compound into a mixed solvent of cyclic ether and alcohol to prepare a magnesium compound solution; and adding a mixture of titanium compound and halogenated hydrocarbon to the magnesium compound solution at low temperature and then elevating the temperature of the resulted solution for reaction, thereby being capable of raising the catalyst production yield and controlling the shape and size of the catalyst particle. Therefore, the inventors have finally completed the present invention, which can provide a solid titanium catalyst for olefin polymerization with controlled shape and size, at high production yield.

Therefore, one of objects of the present invention is to provide a preparation method of a catalyst for olefin polymerization, with high catalyst production yield, having high polymerization activity and well-controlled shape and size of the catalyst particle, and producing polymers with high stereoregularity and high bulk density when used in olefin polymerization.

According to the present invention, a preparation method for a solid titanium catalyst for olefin polymerization is provided, which comprises the steps of: (1) preparing a magnesium compound solution by dissolving a magnesium halide compound into a mixed solvent of a cyclic ether and one or more of alcohol; (2) preparing a carrier by, adding a mixture of titanium compound having a general formula of Ti(OR)ₐX₍₄₋ₐ₎, in which R is an alkyl group having 1-10 carbon atoms, X is a halogen atom and a is an integer of 0-4, and halogenated hydrocarbon, to the magnesium compound solution at −70-70° C. and then elevating the temperature for reaction; and (3) preparing a solid titanium catalyst by reacting the carrier with a titanium compound and an electron donor.

Hereinafter, the preparation method for a catalyst according to the present invention is further described in detail, step by step.

Examples of the magnesium halide compound useful in the step (1) of the preparation method of a catalyst according to the present invention, include halogenated magnesium, alkylmagnesium halide, alkoxymagnesium halide, aryloxymagnesium halide and the like, or a mixture of two or more selected from above. The magnesium halide compound can be used in the form of a complex with other metals.

Cyclic ether useful in the step (1) includes those having 3-6 carbon atoms in the ring or derivatives thereof. Particularly, in terms of the morphological properties of the catalyst, preferred is tetrahydrofuran or 2-methyl tetrahydrofuran, and particularly preferred is tetrahydrofuran.

Alcohol useful in the step (1) includes one or more of primary or polyhydric alcohols having 1-20 carbon atoms, and from the viewpoint of mixing properties with the cyclic ether and dissolution properties of the magnesium halide compound, preferred is one or more of alcohol having 2-12 carbon atoms.

In the step (1), molar ratio of said cyclic ether to one or more of alcohol is preferably 1:0.1-1:10, more preferably 1:0.2-1:5. When the molar ratio is less than 1:0.1 or more than 1:10, effect of controlling the shape and size of catalyst is lowered.

Further, in the step (1), molar ratio of the magnesium halide compound to the mixed solvent of cyclic ether and one or more of alcohol is preferably 1:1-1:20, more preferably 1:2-1:10. When the molar ratio is less than 1:1, dissolution of the magnesium halide compound tends to become poor, and when it is more than 1:20, the required amount of the mixture of titanium compound and halogenated hydrocarbon used to obtain catalyst particles should be excessively increased and control of the shape and size of the catalyst particle becomes difficult.

The temperature for dissolution in the step (1) may be various depending on the types or amounts of cyclic ether and alcohol used, but preferred is in the range of 25-200° C. and more preferred is in the range of 50-150° C. When the temperature for dissolution is lower than 25° C., the dissolution of the magnesium halide compound tends to become difficult, and when it is higher than 200° C., the vapor pressure of the solvent becomes too excessively high to control the reaction.

Also, an aliphatic or aromatic hydrocarbon solvent may be additionally used for dilution in the step (1). Examples of the additional hydrocarbon solvent useful in the step (1) include: aliphatic hydrocarbon such as pentane, hexane, heptane, octane, decane or kerosene; alicyclic hydrocarbon such as cyclohexane or methylcyclohexane; aromatic hydrocarbon such as benzene, toluene, xylene or ethylbenzene; and halogenated hydrocarbon such as trichloroethylene, carbon tetrachloride or chlorobenzene.

Examples of the titanium compound useful in the step (2), represented by the general formula Ti(OR)ₐX₍₄₋ₐ₎, include:titanium tetrahalide such as TiCl₄, TiBr₄ or TiI₄: alkoxytitanium trihalides such as Ti(OCH₃)Cl₃, Ti(OC₂H₅)Cl₃, Ti(OC₂H₅)Br₃ or Ti(O(i-C₄H₉))Br₃; alkoxytitanium dihalide such as Ti(OCH₃)₂Cl₂, Ti(OC₂H₅)₂Cl₂, Ti(O(i-C₄H₉))₂Cl₂ or Ti(OC₂H₅)₂Br₂; alkoxytitanium monohalide such as Ti(OCH₃)₃Cl, Ti(OC₂H₅)₃Cl, Ti(O(i-C₄H₉))₃Cl or Ti(OC₂H₅)₃Br; and tetraalkoxytitanium such as Ti(OCH₃)₄, Ti(OC₂H₅)₄ or Ti(OC₄H₉)₄, and among them, a titanium compound containing halogen is preferably used. Particularly, titanium tetrachloride is more preferably used. Also, mixtures of two or more selected from above compounds may be used. In the general formula of the titanium compound, R is an alkyl group having 1-10 carbon atoms, X is a halogen atom, and a is an integer of 0-4 for balancing the atomic valence of the formula.

As for the halogenated hydrocarbon useful in the step (2), preferred is a halogenated hydrocarbon having 1-20 carbon atoms containing at least one halogen such as monochloromethane, dichloromethane, trichloromethane, tetrachloromethane, monochloroethane, 1,2-dichloroethane, monochloropropane, monochlorobutane, monochloro-sec-butane, monochloro-tert-butane, 1,2-dichlorobutane, monochlorocyclohexane, chlorobenzene, monobromomethane, monobromopropane, monobromobutane, monoiodomethane and the like, and particularly preferred is a chloroalkane compound. Also, mixtures of two or more selected from above compounds may be used.

In the step (2), the mixture of titanium compound and halogenated hydrocarbon is added for reaction with the magnesium compound solution to recrystallize carriers, and the halogenated hydrocarbon and the titanium compound are mixed preferably with the molar ratio of halogenated hydrocarbon: titanium compound being 1:0.05˜1:0.95 and more preferably in the molar ratio of 1:0.1˜1:0.8. When the molar ratio is less than 1:0.05 or more than 1:0.95, the effect of controlling the shape and size of catalyst becomes decreased.

Further, in the step (2), the mixture of titanium compound and halogenated hydrocarbon is added preferably with an amount of 0.1-500 mol, more preferably 0.1-300 mol, and further preferably 0.2-200 mol per one mol of magnesium halide compound.

Further, in the step (2), the temperature for addition of the mixture of titanium compound and halogenated hydrocarbon is preferably −70˜70° C., and more preferably −10˜30° C. When the addition temperature is lower than −70° C., the reaction between the magnesium compound solution and the mixture of titanium compound and halogenated hydrocarbon is not facilitated, and when it is higher than 70° C., the control of the carrier particle shape becomes difficult.

Further, in the step (2), after the addition of the mixture of titanium compound and halogenated hydrocarbon to the magnesium compound solution, the temperature of the resulted mixture is elevated to 50˜150° C. for 0.5-5 hours for sufficient reaction so as to obtain solid particles used as a carrier.

The present invention provides a method for producing a catalyst, with high catalyst production yield, having high polymerization activity and controlled shape and size and being capable of providing a polymer with high stereoregularity, by controlling the shape of the carrier by specifying the addition temperature of the mixture of titanium compound and halogenated hydrocarbon as well as specifying the molar ratio of the magnesium compound and the mixed solvent of a cyclic ether and one or more of alcohol in the step (1).

Examples of the titanium compound useful in the step (3) include titanium halide compound, alkyltitanium halide compound, alkoxytitanium halide compound and the like, and titanium halide compound, particularly titanium tetrachloride, is preferably used.

Examples of the electron donor useful in the step (3) include the compounds containing oxygen, nitrogen or phosphorous such as organic acid, ester of an organic acid, alcohol, ether, aldehyde, ketone, amine, amine oxide, amide and phosphoric ester, and more specifically, alkyl ester of benzoic acid such as ethylbenzoate, ethylbromobenzoate, butylbenzoate, isobutylbenzoate, hexylbenzoate or cyclohexylbenzoate or derivatives thereof, or dialkylphthalate having 2-10 carbon atoms such as diisobutylphthalate, diethylphthalate, ethylbutylphthalate or dibutylphthalate or derivatives thereof.

In the step (3), the carrier resulted from the step (2) is reacted with a titanium compound in the presence of a suitable electron donor to prepare a catalyst. The reaction may be completed in a single step, but from the viewpoint of the catalyst production yield, it is preferred to complete the reaction through repeating the reaction two or more times, for example, by separating the resulted reaction mixture into solid and liquid after the first recation, reacting the residual slurry with additional titanium compound and electron donor one or more times again, and then collecting solid components from the final reaction mixture and drying the collected solid components.

The catalyst prepared by the method of the present invention, may be advantageously used in olefin polymerization, especially propylene polymerization, and suitably used in copolymerization with other olefins such as ethylene, propylene, 1-butene, 1-pentene, 4-methyl-1-pentene, 1-hexene and the like, or with compounds having polyunsaturated bonds such as conjugated or non-conjugated dienes.

### MODE FOR INVENTION

Hereinafter, the present invention is described further in detail, with reference to the following examples, however, the present invention is by no means limited by those illustrative examples.

### EXAMPLE 1

[Catalyst Preparation]

Catalyst was prepared through the following 3 steps.

Step (1): Preparation of a Magnesium Compound Solution

To a 10 L reactor equipped with a mechanical stirrer and substituted with nitrogen atmosphere, 300 g of MgCl₂, 4.5 kg of toluene, 350 g of tetrahydrofuran and 600 g of 1-butanol were added, and the temperature of the reactor was elevated to 110° C. with stirring at 550 rpm and then the eleveated temperature was maintained for 3 hours to give a homogeneous magnesium compound solution.

Step (2): Preparation of a Solid Carrier

After cooling the magnesium compound solution prepared from the step (1) to 16° C., a mixture of 880 g of titanium tetrachloride and 800 g of tetrachloromethane was added thereto, then the temperature of the reactor was elevated to 60° C. over 1 hour, and then the reaction was carried out for 1 hour. After completing the reaction, the resulted mixture was allowed to stand for 30 minutes to settle the resulted carriers down, and the supernatant fluid was removed. The residual slurry in the reactor was washed by repeating 3 times the procedure of adding 2 kg of toluene, stirring, settling the carriers and removing the supernatant fluid to obtain a solid carrier.

Step (3): Catalyst Preparation

To the carrier prepared from the step (2), 2.0 kg of toluene and 2.0 kg of TiCl₄ were added with stirring at 250 rpm, and the temperature of the reactor was elevated to 110° C. over 1 hour, and then the mixture was aged for 1 hour and allowed to stand for 30 minutes to settle the precipitates down, and the supernatant fluid was removed. Then, 2.0 kg of toluene, 2.0 kg of TiCl₄ and 87 g of diisobutylphthalate were further added thereto. The temperature of the reactor was elevated to 120° C. and maintained for 1 hour for reaction, and then the mixture was allowed to stand for 30 minutes to settle the precipitates down and the supernatant fluid was removed. Thereto 2.0 kg of toluene and 2.0 kg of TiCl₄ were added again, the reaction was carried out at 100° C. for 30 minutes, the resulted mixture was allowed to stand to settle the precipitates down, and the supernatant was removed to give catalyst slurry. The washing of the isolated catalyst slurry with 2.0 kg of purified hexane was repeated 7 times in the same manner as above, to prepare a catalyst finally.

The particle size distributions of resulted carrier and catalyst were measured by a laser particle analyzer (Mastersizer X manufactured by Malvern Instruments), and the composition of the catalyst was determined by an inductively coupled plasma analyzer (ICP).

The catalyst prepared as so far described, comprised 2.7 wt % of titanium (Ti) and 17.6 wt % of magnesium (Mg) and had an average particle size of 22 μm and the catalyst production yield was 118%. The catalyst production yield was represented as a percentage of the weight of the resulted catalyst to the weight of MgCl₂ initially added. The average particle size measured and the catalyst production yield was represented in Table 1 below.

[Polymerization]

For evaluating the performance of the catalyst prepared above, propylene polymerization was carried out. In a glove box maintained in nitrogen atmosphere, 10 mg of the catalyst prepared above was weighed and placed into a glass bulb, and the glass bulb was sealed. The bulb was mounted in a 2 L high-pressure reactor so that the glass bulb can be broken when the agitation started, so as to initiate the reaction. The high-pressure reactor was purged with nitrogen for 1 hour to have dry nitrogen atmosphere. To the reactor, triethylaluminum (with the ratio of Al/Ti being 250) and dicyclopentyldimethoxy silane (with the ratio of Si/Al being 0.1) as an external electron donor were added, and the reactor was closed hermetically. 1,000 ml of hydrogen was added to the reactor and 1,200 ml of liquid propylene was added thereto by using a syringe pump, and then agitation was started to break the glass bulb and initiate polymerization reaction, simultaneously elevating the temperature of the reactor to 70° C. over 20 minutes. The polymerization reaction was carried out for 1 hour. After the 1 hour-polymerization reaction, unreacted propylene was vented out, and the temperature of the reactor was lowered to the roan temperature, thereby finally obtaining resulted polymer.

The produced polymer was dried in a vacuum oven at 50° C. and weighed to measure the polymerization activity of the catalyst. Bulk density of the resulted polymer was measured, and also the isotactic index (II, [mmmm] pentad ratio) of the polymer was measured by using NMR (C₁₃-NMR). The results of the measurements are represented Table 1 below.

### EXAMPLE 2

The preparation of a catalyst was carried out in the same manner as in Example 1, except that 800 g of trichloromethane was used instead of 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

### EXAMPLE 3

The preparation of a catalyst was carried out in the same manner as in Example 1, except that 800 g of 1,2-dichloroethane was used instead of 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

### EXAMPLE 4

The preparation of a catalyst was carried out in the same manner as in Example 1, except that 800 g of chlorobenzene was used instead of 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

### EXAMPLE 5

The preparation of a catalyst was carried out in the same manner as in Example 1, except that 800 g of 1,2-dichlorobutane was used instead of 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

### COMPARATIVE EXAMPLE 1

The preparation of a catalyst was carried out in the same manner as in Example 1, except that 700 g of titanium tetrachloride was only used instead of 880 g of titanium tetrachloride and 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

### COMPARATIVE EXAMPLE 2

The preparation of a catalyst was carried out in the same manner as in Example 1, except that 900 g of titanium tetrachloride was only used instead of 880 g of titanium tetrachloride and 800 g of tetrachloromethane in the step (2) of Example 1. The average particle size of the resulted catalyst was measured in the same manner as in Example 1, and the catalyst yield was calculated in the same manner as in Example 1. The measured average particle size and the calculated catalyst yield were represented in Table 1 below.

Further, propylene polymerization was carried out in the same manner as in Example 1, in order for evaluating the performance of the resulted catalyst. With the resulted polymers, properties such as determined in Example 1 were measured in the same manner as in Example 1, and the results are represented in Table 1.

TABLE 1

| | | | | | | Comparative | |
|---|---|---|---|---|---|---|---|
| | Examples | | | | | Examples | |
| | 1 | 2 | 3 | 4 | 5 | 1 | 2 |
| Catalyst production | 118 | 119 | 120 | 116 | 123 | 85 | 95 |
| yield(%) | | | | | | | |
| Average catalyst | 22 | 19 | 21 | 24 | 21 | 34 | 29 |
| particle size (μm) | | | | | | | |
| Polymerization | 32 | 33 | 32 | 35 | 32 | 26 | 27 |
| activity (kg PP/g | | | | | | | |
| catalyst) | | | | | | | |
| Isotactic index(%) | 94.5 | 94.6 | 94.4 | 94.3 | 94.3 | 93.8 | 93.9 |
| Bulk density(g/ml) | 0.41 | 0.42 | 0.40 | 0.42 | 0.42 | 0.38 | 0.39 |

### INDUSTRIAL APPLICABILITY

According to the preparation method of a catalyst of the present invention, it is possible to obtain a catalyst for olefin polymerization having well-controlled spherical particle shape with high catalyst production yield, and, when using the catalyst in olefin polymerization, an olefin polymer with high stereoregularity and high bulk density.

1. A preparation method for a solid titanium catalyst for olefin polymerization, which comprises the steps of:
(1) preparing a magnesium compound solution by dissolving a magnesium halide compound into a mixed solvent of a cyclic ether and one or more of alcohol;
(2) preparing a carrier by, adding a mixture of titanium compound having a general formula of Ti(OR)ₐX₍₄₋ₐ₎, in which R is an alkyl group having 1-10 carbon atoms, X is a halogen atom and a is an integer of 0-4, and halogenated hydrocarbon with the molar ratio of the halogenated hydrocarbon:the titanium compound being 1:0.05-1:0.95, to the magnesium compound solution at −70-70° C. and then elevating the temperature for reaction; and
(3) preparing a solid titanium catalyst by reacting the carrier with a titanium compound and an electron donor.

2. The preparation method for a solid titanium catalyst for olefin polymerization according to claim 1, characterized in that the cyclic ether used in the step (1) is tetrahydrofuran or 2-methyltetrahydrofuran, and the one or more of alcohol used in the step (1) is primary or polyhydric alcohol having 2-12 carbon atoms.

3. The preparation method for a solid titanium catalyst for olefin polymerization according to claim 1, characterized in that the molar ratio of the cyclic ether:the one or more of alcohol used in the step (1), is 1:0.1-1:10.

4. The preparation method for a solid titanium catalyst for olefin polymerization according to claim 1, characterized in that the halogenated hydrocarbon used in the step (2) is a halogenated hydrocarbon having 1-20 carbon atoms containing at least one halogen.

5. The preparation method for a solid titanium catalyst for olefin polymerization according to claim 2, characterized in that the molar ratio of the cyclic ether:the one or more of alcohol used in the step (1), is 1:0.1-1:10
